(19) United States
(12) Patent Application Publication
(10) Pub. No.: US 2026/0063493 A1
(43) Pub. Date: Mar. 5, 2026

(54) Method and Device for Detecting Entry of Liquid into a Housing of a Control Unit and a Vehicle comprising the Device

(71) Applicant: Robert Bosch GmbH, Stuttgart (DE)

(72) Inventors: Deivaraja Ramasamy, München (DE); Wadim Okley, Leinzell (DE)

(21) Appl. No.: 19/308,251

(22) Filed: Aug. 24, 2025

(30) Foreign Application Priority Data
Aug. 27, 2024 (DE) 10 2024 208 127.2

(51) Int. Cl. G01M 3/04; B62D 5/04

(52) U.S. Cl. CPC G01M 3/04; B62D 5/0406

(57) ABSTRACT

A device and method for detecting entry of liquid, in particular liquid including water, for example water, into a housing of a control unit, in particular a control unit of a steer-by-wire steering system are disclosed. The method includes (i) measuring a first characteristic variable, which characterizes a temperature within the housing, (ii) measuring a second characteristic variable, which characterizes a relative humidity within the housing, (iii) storing in each case at least one value of the first characteristic variable and the second characteristic variable, which in each case characterizes a temperature and relative humidity present within the housing at at least one previous point in time, in particular at predetermined time intervals, (iv) determining an operating state of the control unit depending on a power consumption of the control unit and/or the first characteristic variable, wherein the control unit includes a first operating state and a second operating state, wherein the first operating state has a lower power consumption than the second operating state, and (v) detecting the entry of liquid depending on the determined operating state, the first characteristic variable, and the second characteristic variable.

This application claims priority under 35 U.S.C. § 119 to application no. DE 10 2024 208 127.2, filed on Aug. 27, 2024 in Germany, the disclosure of which is incorporated herein by reference in its entirety.

### BACKGROUND

The present disclosure relates to a method and device for detecting entry of liquid, in particular liquid comprising water, for example water, into a housing of a control unit and a vehicle comprising the device.

Entry of water into a control unit, for example caused by a defect, for example a leakage, of a housing may result in damage or failure of a control unit's electronics. This functional failure may jeopardize safe operation of a vehicle comprising the control unit. Moisture sensors are used for various electronics in a vehicle to increase the application safety of the electronics. Direct limit values of relative humidity are useful for detecting condensation. An evaluation of the relative humidity is performed locally at a location of the moisture sensor. As the homogeneity of a temperature within a housing of the electronics is not given, local condensation can occur, for example condensation on a heat sink, on which the temperatures are below the dew point. Accordingly, condensation water formation does not necessarily mean that the housing of electronics is damaged.

This means that it is desirable to be able to reliably detect entry of liquid into a control unit.

### SUMMARY

The object of the disclosure is achieved by way of a method, a device, and a vehicle comprising the device according to the description below.

The method for detecting entry of liquid, in particular liquid comprising water, for example water, into a housing of a control unit, in particular a control unit of a steer-by-wire steering system, comprises: measuring a first characteristic variable, which characterizes a temperature within the housing; measuring a second characteristic variable, which characterizes a relative humidity within the housing; storing in each case at least one value of the first characteristic variable and the second characteristic variable, which in each case characterizes a temperature and relative humidity present within the housing at at least one previous point in time, in particular at predetermined time intervals; determining an operating state of the control unit depending on a power consumption of the control unit and/or the first characteristic variable, wherein the control unit comprises a first operating state and a second operating state, wherein the first operating state has a lower power consumption than the second operating state; detecting the entry of liquid depending on the determined operating state, the first characteristic variable, and the second characteristic variable. For example, the first operating state is a standby operating state, while the second operating state characterizes an operating state, powered state, or load operation. The first operating state is characterized, for example, by a power consumption or current consumption of the control unit of below 200 μA, in particular 100 μA. In the first operating state the control unit, for example, substantially does not have any self-heating, while in the second operating state, due to the higher power consumption, higher power dissipations result that cause the temperature within the housing to increase. By detecting depending on the operating state, entry of liquid into the housing can be recognized more reliably because the relative humidity as well as the temperature within the housing differs depending on the operating states.

It may be provided that the method in the first operating state comprises: determine a first parameter, which characterizes a relative humidity dynamic within the housing, in particular a period of time, in which the relative humidity within the housing changes by a predetermined amount, depending on the, in each case, at least one saved value of the second characteristic variable and the detected second characteristic variable; comparing the first parameter with a predetermined first threshold value, wherein entry of liquid is detected, when the first threshold exceeds the first parameter, especially when the time period is shorter; wherein the first parameter is determined, if the first characteristic has a behavior that characterizes an equilibrium between a temperature outside of the housing and the temperature within the housing, such as constant behavior. The balance between the temperature outside the housing and inside the housing is a thermal balance. In the second operating state, temperature variations of, for example, 10° C. may occur within two minutes. It is conceivable that the first characteristic variable has a constant behavior when there is a temperature dynamic within the housing, for example, of below 2-3° C./min, in particular below 1° C./min. The first parameter may be described as a rise time in which the relative humidity increases by a predetermined amount, for example 10%. At a constant temperature, the relative humidity within the housing and a relative humidity outside balance over time. This behavior is comparable to a gas exchange behavior. In an undamaged control unit, this equalization takes place via pressure compensation elements and also interfaces for connecting lines. If the housing is damaged, for example by a leakage, this equalization is achieved in a shorter time than with the undamaged housing. If liquid has also entered the housing, the relative humidity within the housing, in particular, increases more rapidly at constant temperature, which is why the entry of liquid can be detected by way of the first parameter and the first threshold value. The threshold value is determined, for example, by sampling a housing of the control unit into which no liquid has entered. The first parameter may be efficiently determined using the stored values. In addition, the comparison of the first parameter with the predetermined first threshold allows for a computationally efficient and reliable detection of the entry of liquid in the first operating state, in which the temperature within the housing is substantially constant.

It may be provided that the method in the second operating state comprises: determining a second threshold value for the second characteristic variable dependent on a power dissipation of the control unit characterizing a determinable increase in temperature within the housing; comparing the second characteristic variable with the determined second threshold value, wherein entry of liquid is detected when the second threshold value is exceeded by the second characteristic variable. The power dissipation characterizes a difference between a power supplied to the control unit and a power dissipated by the control unit. The power dissipation causes dissipation and heating of the control unit. In the second operating state, the temperature within the housing rises due to dissipation, which also creates a corresponding relative humidity dynamic within the housing. By way of comparing the second characteristic variable with the second threshold value, which is dependent on a power dissipation of the control unit and accordingly varies, entry of liquid into the housing can be reliably and efficiently detected for different operating points of the control unit.

It may be provided that a temperature outside of the housing is estimated depending on the increase in the temperature within the housing and depending on the recorded first characteristic variable, wherein, depending on the estimated temperature outside of the housing, a maximum possible relative humidity within the housing is determined without entry of liquid into the housing, wherein the second threshold value characterizes this maximum relative humidity within the housing. Thus, entry of liquid into the housing is likely to be correctly detected.

It may be provided that an August-Roche-Magnus model is used to determine the second threshold. This model allows for efficient determination of the second threshold.

It may be provided that the method in the second operating state comprises: determining a second parameter, which characterizes a variation of the second characteristic variable relative to a variation of the first characteristic variable, in particular, a change in relative humidity within the housing over a change in temperature within the housing; when the second parameter assumes a positive value and when the first characteristic variable characterizes a positive jump of the temperature within the housing, measuring a value of the second parameter after a predetermined period of time based on the positive jump of the temperature within the housing and comparing the measured second parameters before the positive jump of the temperature with the measured value of the second parameter after the predetermined period of time, wherein entry of liquid is detected in the housing, if the measured second characteristic variable characterizes before the positive jump of the temperature a lower or the same relative humidity than the value of the second characteristic after the predetermined period of time. As a result, it is possible according to the method to distinguish a brief increase in relative humidity caused by moisture storage effects of control unit components from an actual entry of liquid into the control unit housing. For example, the predetermined period of time may be determined by sampling a control unit without ingress of liquid. The components of the control unit are, for example, plastic parts of the housing, epoxy layers of semiconductors, or printed circuit boards that can absorb and release moisture.

It may be provided that the method in the second operating state comprises: when the second parameter assumes a positive value, determining a third parameter, which characterizes an absolute humidity within the housing depending on the first characteristic variable and the second characteristic variable, in particular by way of an August-Roche-Magnus model; determining a fourth parameter, which characterizes a variation of the third parameter relative to a variation of the first characteristic variable, in particular, a change in absolute humidity over a change in temperature within the housing depending on the third parameter and the first characteristic variable; comparing the fourth parameter with a predetermined third threshold value, wherein entry of liquid is detected in the housing when the third threshold value of the fourth parameter is exceeded. By using the absolute humidity, the method of reliably detecting the entry of liquid into the housing is improved. For example, the third threshold characterizes an amount of moisture that may be absorbed and therefore released by the components of the control unit. For example, the third threshold value may be determined by sampling a control unit without entry of liquid. Thus, the method may better differentiate between an actual entry of liquid into the housing and a humidity dynamic within the housing caused by moisture storage effects.

The device for detecting entry of liquid, in particular liquid comprising, for example water, into a housing of a control unit, in particular a control unit of a steer-by-wire steering system, comprises a first sensor device, which is configured to have a first characteristic variable, which is characterized to measure a temperature within the housing and a second sensor device, which is configured to measure a second characteristic variable, which is characterized to measure a relative humidity within the housing, wherein the device is configured to perform a method according to the above embodiments.

It may be provided that the first sensor device and the second sensor device are configured as a combined sensor device.

The vehicle includes a control unit having a housing and a device according to the above embodiments.

### BRIEF DESCRIPTION OF THE DRAWINGS

Further advantageous embodiments will become apparent from the drawings and the following description. The drawings show:

FIG. 1 a flow chart of a method for detecting entry of liquid into a housing of a control unit;

FIG. 2 an excerpt of a flow chart of an embodiment of the method;

FIG. 3 an excerpt of a flow chart of an embodiment of the method;

FIG. 4 an excerpt of a flow chart of an embodiment of the method;

FIG. 5 development over time of a temperature and relative humidity within a housing;

FIG. 6 development over time of a temperature and relative humidity within a housing;

FIG. 7 an excerpt of a flow chart of an embodiment of the method;

FIG. 8 a schematic illustration of a device for detecting entry of liquid into a housing of a control unit;

FIG. 9 a flowchart of one embodiment of the method.

### DETAILED DESCRIPTION

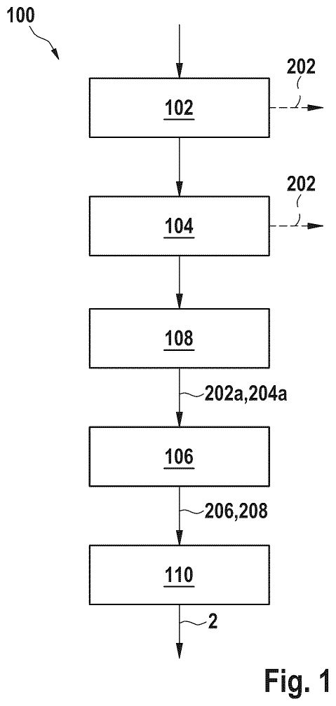

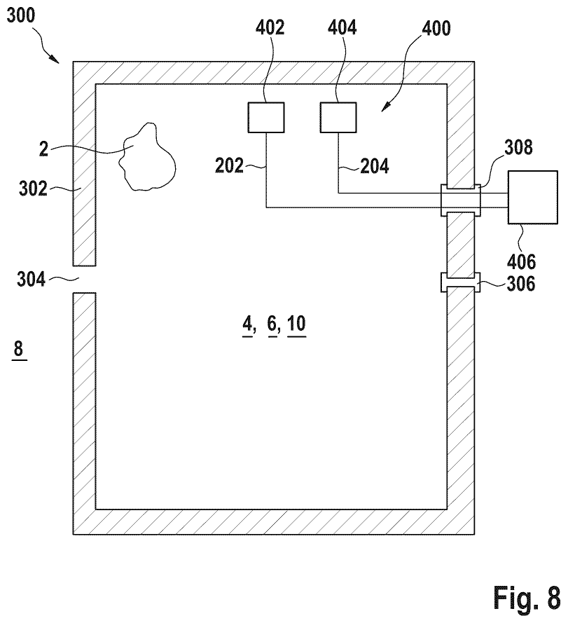

FIG. 1 shows a flow chart of a method 100 for detecting an entry 2 of liquid, in particular liquid comprising water, for example water, into a housing 302 of a control unit 300, in particular a control unit 300 of a steer-by-wire steering system (FIG. 8). The method 100 comprises measuring 102 a first characteristic variable 202 characterizing a temperature 4 within the housing 302 (FIG. 8). For example, the first characteristic variable 202 may be the temperature 4 within the housing 302. The method 100 also includes measuring 104 a second characteristic variable 204 characterizing a relative humidity 6 within the housing 302 (FIG. 8). The second characteristic variable 204 may be the relative humidity 6 within the housing 302. Relative humidity is a ratio expressed in percent between the humidity present and the amount that would be present if the air were saturated.

The method 100 includes determining 106 an operating state of the control unit 300 depending on a power consumption of the control unit 300 and/or first characteristic variable 202, wherein the control unit 300 includes a first operating state 206 and a second operating state 208, wherein the first operating state 206 has a lower power consumption than the second operating state 208. For example, if the control unit comprised by a vehicle is a steer-by-wire steering system, the second operating state 208 is an operating state in which the vehicle is operating and the control unit is used to control an actuator of the steer-by-wire steering system. For example, the first operating state 206 is present in this example when the vehicle is stopped and not ready to drive.

The method 100 includes storing 108 in each case at least one of a value 202a, 204a of the first characteristic variable 202 and the second characteristic variable 204 that in each case characterizes a temperature 4 and relative humidity 6 within the housing 302 present at at least a previous time, particularly at predetermined time intervals. It may be provided that a plurality of values 202a and 204b may be stored in a table or that in each case only a value 202a and 204b may be stored from a previous time point. The time intervals may be fixed or variable. The time intervals, for example, may be predetermined depending on a processor and/or memory capacity of a computing device to be performed in the method.

The method 100 includes detecting 110 the entry 2 of liquid depending on the determined operating state 206, 208, the first characteristic variable 202, and the second characteristic variable 204.

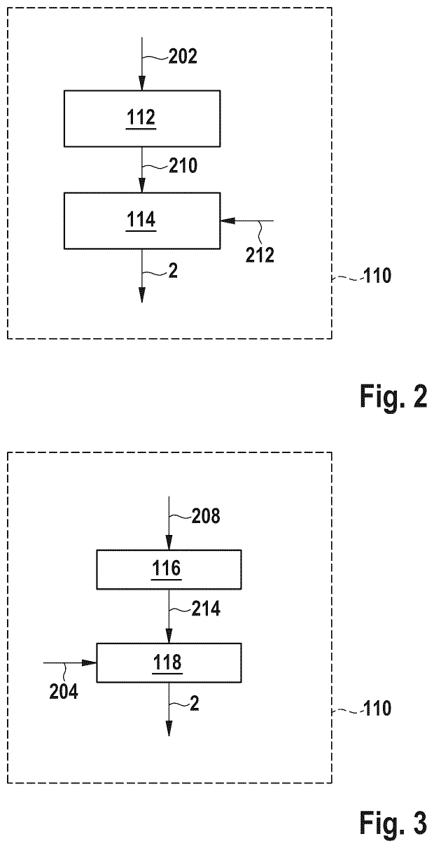

FIG. 2 shows an excerpt of an embodiment of method 100. This excerpt relates to a procedure for detecting 110 entry 2 of liquid. It may be provided that in the first operating state 206, the method 100 may include determining 112 a first parameter 210 characterizing a relative humidity 6 dynamic within the housing 302, particularly a period of time in which the relative humidity 6 within the housing 302 changes by a predetermined amount depending on the, in each case, at least one stored value 204a of the second characteristic variable 204 and the detected second characteristic variable 204. For example, the first parameter may be referred to as rise time. The predetermined amount may be, for example, 2-10% relative humidity (rH).

The embodiment of the method 100 also includes comparing 114 of the first parameter 210 to a predetermined first threshold 212, wherein an entry 2 of liquid is detected when the first threshold 212 is exceeded by the first parameter 210, particularly when the time period is shorter. The first threshold 212, for example, may be sampled by constant temperature experiments on a control unit into which no liquid has entered. These control devices are hereinafter referred to as control devices having a good housing or good control devices. If the experiments are performed by way of an experiment chamber that can regulate relative humidity, a dynamic or rise time of the experiment chamber may considered in conjunction with

$${t}_{r , good housing} = \sqrt{{t}_{r , meas}^{2} - {t}_{r , chamber}^{2}}$$

A t_{r,good housing} rise time for, for example, 10% rH of a good control unit depicts t_{r,meas} a measured rise time for, for example, 10% rH of the good control unit and t_{r,chamber} a rise time for, for example, 10% rH of the test chamber t_{r,chamber} can be determined, for example, via separate tests or data sheets of the test chamber. The average rise time t_{r,good housing} can thereby be used as the first threshold value 212 or time duration or rise time. It is conceivable that the first threshold 212 will be applied, for example, by further experimentation.

The first parameter 210 is determined 112 when the first characteristic variable 202 has a behavior that characterizes an equilibrium between a temperature 8 outside of the housing 302 (FIG. 8) and the temperature 4 within the housing 302, for example a constant behavior. At a constant temperature 4 within the housing, in a good housing, the relative humidity changes slowly, even if a relative humidity 8 is changed outside of the housing. When liquid has entered the housing, the relative humidity 6 within the housing 302 changes more quickly. This effect is detected through comparison 114. This effect occurs, in particular, with an increase in relative humidity 6 within the housing 302.

FIG. 3 shows an excerpt of one embodiment of method 100 in a flowchart. This excerpt relates to a procedure for detecting 110 of entry 2 of liquid. It may be contemplated that in the second operating state 208, the method 100 includes determining 116 a second threshold 214 for the second characteristic variable 204 depending on a power dissipation of the control unit 300 characterizing a determinable increase in temperature 4 within the housing 302. In addition, in this embodiment, the method 100 includes comparing 118 of the second characteristic variable 204 to the determined second threshold 214, wherein an entry 2 of liquid is detected when the second threshold 214 is exceeded by the second characteristic variable 204. For example, the second threshold 214 and the second characteristic variable 204 may be expressed as relative humidity rH in percent.

For example, the power dissipation may be determined by a difference in supplied power and output power of control unit 300, for example via shunt resistors. The power dissipation characterizes a heating or a temperature increase within the housing.

It may be provided that depending on the increase in temperature 4 within the housing 302 and depending on the measured first characteristic variable 202, a temperature 8 outside of the housing 302 is estimated, wherein, depending on the estimated temperature 8 outside of the housing 302, a maximum possible relative humidity is determined within the housing 302 without entry of liquid 2 into the housing 302, wherein the second threshold 214 characterizes this maximum relative humidity within the housing 302. For a particular temperature 8 outside of the housing 302 and a particular increase in temperature 4 within the housing, if a good housing 302 is present, only a limited value of relative humidity 6 within the housing 302 can be reached at a conceived humidity outside of the housing 302 of 100% rH because the temperature 4 within the housing 302 is higher due to the increase in temperature 4 within the housing 302. Based on the determined increase in temperature 4 within the housing 302 and the measured temperature 4 within the housing 302, the temperature outside of the housing 302 is estimated and the second threshold value 214 is determined by way of a conceived relative humidity outside of the housing of 100% rH.

It may be provided that an August-Roche-Magnus model is used to determine 116 the second threshold value 214. This model describes a ratio between different temperatures and relative humidity in an adiabatic system as follows:

$$\frac{{rH}_{1}}{{rH}_{2}} = exp ( \frac{b \cdot c \cdot ( {T}_{1} - {T}_{2} )}{( c + {T}_{1} ) ( c + {T}_{2} )} ) .$$

Here, rH₁ describes a first relative humidity that may be used, for example, to determine the second threshold value 214. The variable rH₂ depicts a second relative humidity, which may be set at 100% for example to determine the second threshold value 214. The variable T₁ describes a first temperature at which the first relative humidity prevails. In the example of determining the second threshold value 214, for example, T₁ describes the measured temperature 4 within the housing 302. The variable T₂ depicts a second temperature at which the second relative humidity prevails. In the example of determining the second threshold value 214, for example, T₂ describes the estimated temperature outside of the housing 302 depending on power dissipation.

For example, the parameters a, b and c may be parameterized using the following tabular representation:

| Temperature range [° C.] | a [10² Pa] | b | c [° C.] |
|---|---|---|---|
| General | 6.1121 | 17.625 | 243.04 |
| (−40, 0) | 6.1121 | 17.966 | 247.15 |
| (0, 50) | 6.1121 | 17.368 | 238.88 |
| (0, 100) | 6.1121 | 17.123 | 234.95 |

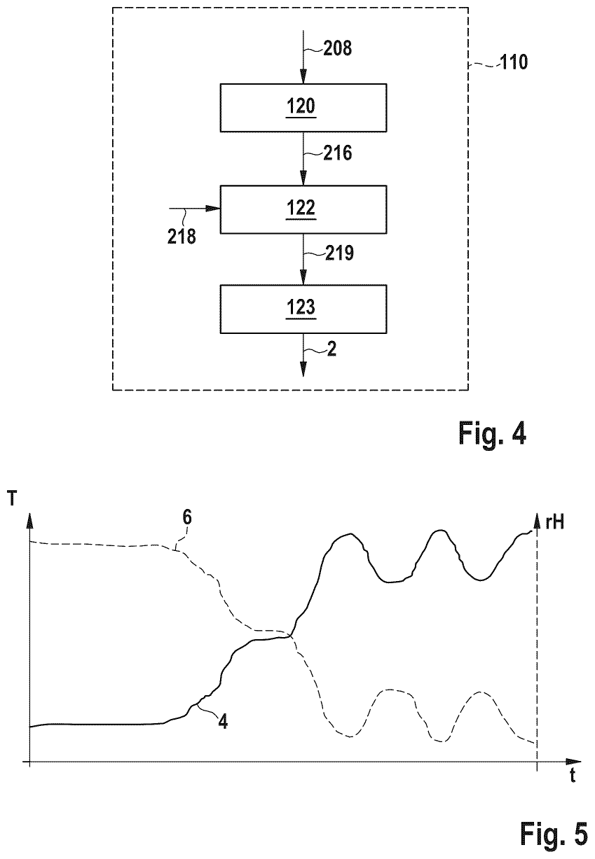

FIG. 4 shows an excerpt of one embodiment of method 100 in a flowchart. This excerpt relates to a procedure for detecting 110 the entry 2 of liquid. It may be provided that in the second operating state 208, the method 100 may include determining 120 a second parameter 216 characterizing a variation of the second characteristic variable 204 relative to a variation of the first characteristic variable 202, in particular, a change in relative humidity 6 within the housing 302 over a change in temperature 4 within the housing 302. The second parameter 216 may be expressed as a differential

$$\frac{drH}{dT} .$$

In addition, the method 100 according to this embodiment comprises measuring 122 a value 219 of the second characteristic variable 204 after a predetermined period of time 218 on the basis of a positive jump 12 (FIG. 8) of the temperature 4 within the housing 302 and comparing 123 the measured second characteristic variable 204 prior to the positive jump 12 of the temperature 4 with the measured value 219 of the second characteristic variable 204 after the predetermined period of time 218. Measuring 122 and comparing 123 is performed when the second parameter 216 reaches a positive value and when the first characteristic variable 202 characterizes the positive jump 12 of the temperature 4 within the housing 302. In so doing, entry 2 of liquid into the housing 302 is detected when the measured second characteristic variable 204 characterizes a lower or the same relative humidity rH before the positive jump 12 of the temperature 4 than the value 219 of the second characteristic variable 204 after the predetermined time period 218.

FIG. 5 shows an exemplary development over time of the temperature 4 within the housing 302 and relative humidity 6 within the housing 302. In this case, the parameter T denotes a temperature, rH a relative humidity, and t the time. The housing 302 in this example is a good housing 302 without entry 2 of liquid. As the temperature increases, the saturation limit of moisture also rises. At a constant absolute amount of moisture, the relative humidity drops as the temperature increases and vice versa. Accordingly, a negative value of the differential

$$\frac{drH}{dT}$$

or second parameter 216 means, for example, that no liquid has entered 2 the housing 302. If the differential

$$\frac{drH}{dT}$$

or the parameter 216 is positive or greater than zero, there may be an entry 2 of liquid into housing 302. Due to moisture storage effects of the components of the control unit 300, as temperatures 2 within housing 302 increase, there may be a release of the absorbed moisture, and, accordingly, a brief increase in relative humidity 6 within housing 302 as absolute humidity is increased.

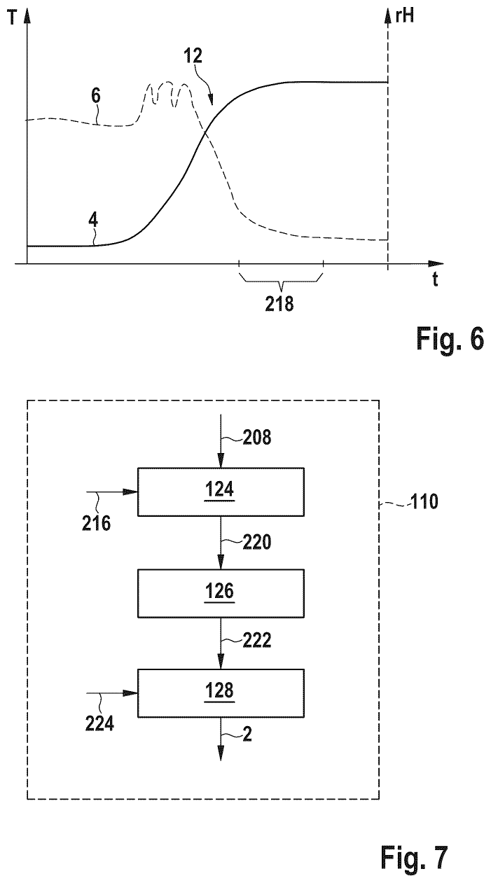

FIG. 6 shows an exemplary development over time of the temperature 4 within the housing 302 and relative humidity 6 within the housing 302. The temperature 4 within the housing 302 experiences the positive jump 12. The progression of the relative humidity 6 within the housing shows the brief increase in relative humidity caused by the moisture storage effects. This brief increase decreases in a good housing 302 in a certain time following the positive jump 12. The predetermined time period 218 characterizes this certain time. For example, the predetermined time period 218 may be determined by attempts at a good control unit 300.

To distinguish an actual entry 2 of liquid from a brief increase in relative humidity 6 within the housing 302, the measured second characteristic variables 204 before the positive jump 12 of the temperature 4 is compared 123 with the measured value 219 of the second characteristic variable 204 after the predetermined time period 218. If the relative humidity 6 within the housing 302 does not decrease after the predetermined time period 218, there is a high probability of an entry 2 of liquid into the control unit 300 or the housing 302 of the control unit 300.

FIG. 7 shows an excerpt of one embodiment of method 100 in a flowchart. This excerpt relates to a procedure for detecting 110 the entry 2 of liquid. It may be provided that in the second operating state 208, the method 100 may determine 124 a third parameter 220 that characterizes absolute humidity 10 within the housing 302 depending on the first characteristic variable 202 and the second characteristic variable 204, particularly by way of an August-Roche-Magnus model, when the second parameter 216 assumes a positive value. For example, the absolute humidity aH may be used as the third parameter 220. Absolute humidity, expressed in grams of water vapor per cubic meter of air volume, for example, is a measure of the actual amount of water vapor (moisture) in the air regardless of the air temperature. The higher the amount of water vapor, the higher the absolute humidity. By way of the following context, the third parameter 220, for example, may be determined as absolute humidity 10 within the housing 302.

$${ρ}_{v} = 216.7 \cdot \frac{rH \cdot a \cdot exp ( \frac{bT}{c + T} )}{{T}_{0} + T}$$

Thereby, ρᵥ represents an absolute humidity aH, for example the third parameter 220. rH is a relative humidity, for example the relative humidity 6 within the housing 302 or the second characteristic variable 204. T describes a temperature, for example the temperature 4 within the housing 302 or the first characteristic variable 202. T₀ is a parameter that describes the absolute zero point with its value, for example 273.15° C. The parameters a, b and c may be parameterized with the tabular representation described above.

Also in this embodiment, the method 100 includes determining 126 a fourth parameter 222 characterizing a variation of the third parameter 220 relative to a variation of the first characteristic variable 202, in particular, a change in absolute humidity 10 over a change in temperature 4 within the housing 302, depending on the third parameter 220 and the first characteristic variable 202. The fourth parameter 222 may be expressed as a differential

$$\frac{daH}{dT} .$$

Furthermore, in this embodiment, the method 100 includes comparing 128 the fourth parameter 222 to a predetermined third threshold 224, wherein an entry 2 of liquid is detected into the housing 302 when the third threshold 224 is exceeded by the fourth parameter 222. As a result of the moisture storage effects, the absolute humidity 10 within the housing increases with increasing temperature 4 within the housing, thus the differential

$$\frac{daH}{dT}$$

and, for example, the fourth parameter 222 have a positive value. If there is liquid in the control unit or if an entry 2 of liquid into the control unit 300 has taken place, the absolute humidity 10 within the housing 302 rises faster with the increasing temperature 4 within the housing. That is to say, the differential

$$\frac{daH}{dT}$$

and, for example, the fourth parameter 22 will take on larger values. By sampling using a good control unit 300, the moisture storage effect may be identified and the third threshold 224 for the fourth parameter 222 or the differential

$$\frac{daH}{dT}$$

may be determined.

The embodiments described above of detecting 110 may be comprised individually or in parallel in any combination of the method 100. It may be provided that entry 2 of liquid is detected in the control unit 300 or the housing 302 when one of these procedures detects the entry 2 of liquid. Simply put, it may be provided that the procedures within method 100 may be associated with a logical ODER upon detection 110.

FIG. 8 shows in a schematic diagram the control unit 300 and a device 400 for detecting an entry 2 of liquid, particularly liquid comprising water, for example water, into the housing 302 of the control unit 300, in particular a control unit 300 of a steer-by-wire steering system. The device 400 includes a first sensor device 402 configured to measure 102 the first characteristic variable 202 characterizing the temperature 4 within the housing 302 and a second sensor device 404 configured to measure the second characteristic variable 204 characterizing the relative humidity 6 within the housing 306.

It may be provided that the device 400 comprises a computing device 406 configured to perform the method 100. For example, the computing device 406 may be an outsourced control unit or a computing unit integrated into the control unit 300.

In the example shown, the control unit 300 in its housing 302 includes a defect 304 through which the liquid, for example water, has entered 2. In an undamaged state of the housing 302, two humidity is exchanged inside and outside of the housing, for example, via interfaces 308 for conduits and connections and/or pressure balance valves 306. This exchange is affected by the defect 304 and, in particular, the entry 2 of liquid. This interference is analyzed by way of the device 400 and the method 100, whereby the entry 2 of liquid can be detected.

It may be provided that the first sensor device 402 and the second sensor device 404 may be configured as a combined sensor device.

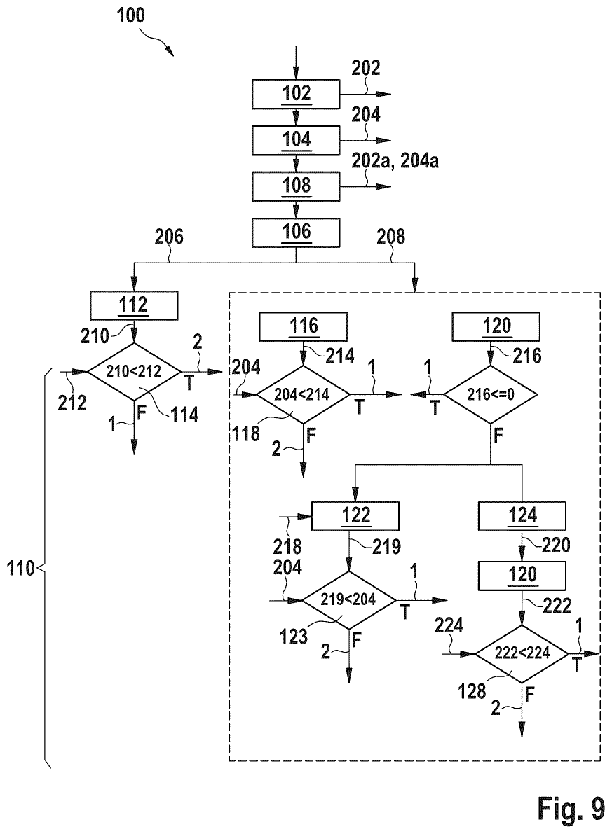

FIG. 9 shows a flow chart of one embodiment of method 100 in which the above-mentioned methods of detecting 110 are combined. By way of illustration, individual method steps are shown by way of logical comparison operators. In this case, the comparison operator “<” means smaller, “>” means larger, and “<=” smaller than or equal to, and “>=” greater than or equal to. The results of these comparisons are presented with abbreviations “T” for true and “F” for false. The reference numeral 2 symbolizes a detected entry 2 of liquid into the housing 302 and the reference numeral 1 symbolizes that no liquid has entered the housing 302 or the control unit 300.

It may be contemplated that alternative model approaches to the August-Roche-Magnus model may be used to determine the second threshold value 212 and/or the third parameter 220 to enable the determination of the second threshold value 212 and/or the third parameter 220.

What is claimed is:

1. A method for detecting an entry of liquid into a housing of a control unit, comprising:
measuring a first characteristic variable which characterizes a temperature within the housing;
measuring a second characteristic variable which characterizes a relative humidity within the housing;
storing in each case at least one value of the first characteristic variable and the second characteristic variable which in each case characterizes a temperature and relative humidity present within the housing at at least one previous point in time;
determining an operating state of the control unit depending on a power consumption of the control unit and/or the first characteristic variable, wherein the control unit comprises a first operating state and a second operating state, and wherein the first operating state has a lower power consumption than the second operating state; and
detecting the entry of liquid depending on the determined operating state, the first characteristic variable, and the second characteristic variable.

2. The method according to claim 1, further comprising, in the first operating state:
determining a first parameter which characterizes a relative humidity dynamic within the housing including a period of time in which the relative humidity within the housing changes by a predetermined amount depending, in each case, on the at least one stored value of the second characteristic variable and the measured second characteristic variable; and
comparing the first parameter with a predetermined first threshold value, wherein entry of liquid is detected when the first threshold value is exceeded by the first parameter,
wherein the first parameter is determined when the first characteristic variable has a behavior that characterizes an equilibrium between a temperature outside of the housing and the temperature within the housing.

3. The method according to claim 2, further comprising, in the first operating state:
determining a second threshold value for the second characteristic variable depending on a power dissipation of the control unit which characterizes a determinable increase in temperature within the housing; and
comparing the second characteristic variable with the determined second threshold value, wherein the entry of liquid is detected when the second threshold value is exceeded by the second characteristic variable.

4. The method according to claim 3, wherein:
depending on the increase in temperature within the housing and depending on the measured first characteristic variable, a temperature outside of the housing is estimated,
depending on the estimated temperature outside of the housing, a maximum possible relative humidity is determined within the housing without entry of liquid into the housing, and
the second threshold characterizes the maximum relative humidity within the housing.

5. The method according to claim 4, wherein an August-Roche-Magnus model is used to determine the second threshold value.

6. The method according to claim 1, further comprising, in the second operating state:
determining a second parameter which characterizes a variation of the second characteristic variable relative to a variation of the first characteristic variable including a change in relative humidity within the housing over a change in temperature within the housing; and
when the second parameter assumes a positive value and when the first characteristic variable characterizes a positive jump of the temperature within the housing, measuring a value of the second characteristic variable after a predetermined time period starting from the positive jump of the temperature within the housing and comparing the measured second characteristic variable before the positive jump of the temperature with the measured value of the second characteristic variable after the predetermined time period, wherein entry of liquid into the housing is detected if the measured second characteristic variable before the positive jump of the temperature characterizes a lower or equal relative humidity than the value of the second characteristic variable after the predetermined time period.

7. The method according to claim 6, further comprising, in the second operating state:
when the second parameter assumes a positive value, determining a third parameter which characterizes an absolute humidity within the housing depending on the first characteristic variable and the second characteristic variable;
determining a fourth parameter which characterizes a variation of the third parameter relative to a variation of the first characteristic variable including a change in absolute humidity over a change in temperature within the housing depending on the third parameter and the first characteristic variable; and
comparing the fourth parameter with a predetermined third threshold value, wherein entry of liquid into the housing is detected when the third threshold value is exceeded by the fourth parameter.

8. A device for detecting an entry of liquid into a housing of a control unit, comprising a first sensor device which is configured to measure a first characteristic variable, which characterizes a temperature within the housing, and a second sensor device which is configured to measure a second characteristic variable, which characterizes a relative humidity within the housing, and wherein the device is configured to perform the method according to claim 1.

9. The device according to claim 8, wherein the first sensor device and the second sensor device are configured as a combined sensor device.

10. A vehicle, comprising:
a control unit having a housing; and
a device according to claim 8.

11. The method according to claim 1, wherein the liquid comprises water.

12. The method according to claim 11, wherein the liquid is water.

13. The method according to claim 1, wherein the control unit is a control unit of a steer-by-wire steering system.

14. The method according to claim 1, wherein the at least one previous point in time is at predetermined time intervals.

15. The method according to claim 2, wherein the behavior is a constant behavior.

16. The method according to claim 7, wherein determining the third parameter includes determining the third parameter by way of an August-Roche-Magnus model;

17. The device according to claim 8, wherein the liquid comprises water.

18. The device according to claim 17, wherein the liquid is water.

19. The device according to claim 8, wherein the control unit is a control unit of a steer-by-wire steering system.
